(19) United States
(12) Patent Application Publication
(10) Pub. No.: US 2011/0048209 A1
(43) Pub. Date: Mar. 3, 2011

(54) Cutting Frame of High Cutting Efficiency

(75) Inventors: Hokyung Lee, Daejeon (KR); Soonki Heo, Daejeon (KR); Jaein Choi, Daejeon (KR)

(73) Assignee: LG Chem, Ltd., Seoul, Youngdungpo-gu (KR)

(21) Appl. No.: 12/677,082

(22) PCT Filed: Aug. 27, 2008
(86) PCT No.: PCT/KR2008/005001

§ 371 Date: Oct. 22, 2010

(30) Foreign Application Priority Data
Sep. 8, 2007 (KR) 10-2007-0091263

(51) Int. Cl. B26D 1/00

(52) U.S. Cl. 83/651

(57) ABSTRACT

Disclosed herein is a cutting frame including a plurality of cutters for cutting two or more kinds of rectangular unit pieces having relatively small sizes from a rectangular base material at a predetermined inclination, the cutters being mounted or formed in the cutting frame such that the cutters correspond to the rectangular unit pieces, wherein the cutters are formed in the cutting frame in an array structure of the rectangular unit pieces in which largest-sized rectangular unit pieces are arranged at a central part of a base material based on the height of the base material in the longitudinal direction of the base material, and small-sized rectangular unit pieces are arranged above and below the largest-sized rectangular unit pieces.

### FIELD OF THE INVENTION

The present invention relates to a cutting frame of high cutting efficiency, and, more particularly, to a cutting frame including a plurality of cutters for cutting two or more kinds of rectangular unit pieces having relatively small sizes from a rectangular base material at a predetermined inclination, the cutters being mounted or formed in the cutting frame such that the cutters correspond to the rectangular unit pieces, wherein the cutters are formed in the cutting frame in an array structure of the rectangular unit pieces in which largest-sized rectangular unit pieces are arranged at a central part of a base material based on the height of the base material in the longitudinal direction of the base material, and small-sized rectangular unit pieces are arranged above and below the largest-sized rectangular unit pieces.

### BACKGROUND OF THE INVENTION

A technology for cutting a rectangular base material having a relatively large size to manufacture a plurality of rectangular unit pieces having relatively small sizes has been adopted in various fields. For example, a base material sheet having a predetermined width and a long length is repeatedly cut by a cutting frame to simultaneously manufacture a plurality of rectangular unit pieces though a one-time cutting process.

Meanwhile, the size (width) of the base material is specified, whereas the size of the rectangular unit pieces may vary as needed, due to various factors, such as the limitation of base material suppliers, the efficiency aspect of the manufacturing process, the fluctuation in demand of rectangular unit pieces, etc. In this case, the cutting efficiency greatly varies depending upon in which structure the cutting frame is constructed, i.e., in which structure cutters for cutting the rectangular unit pieces from the base material are arranged, when cutting a plurality of desired rectangular unit pieces based on the size of the base material. The low cutting efficiency increases the amount of scrap, produced from the base material, which will be disposed of after the cutting process, with the result that eventually, the manufacturing costs of the rectangular unit pieces increase.

When the size (width and length) of a base material is in constant proportion to the size (lateral length and longitudinal length) of specific rectangular unit pieces, it is possible to minimize the cutting loss by sequentially arranging the rectangular unit pieces such that the rectangular unit pieces are brought into contact with one another at positions having such constant proportion. However, when such constant proportion is not formed, the cutting loss may vary depending upon the array structure of the rectangular unit pieces.

Furthermore, when the rectangular unit pieces are to be cut at a predetermined angle to the longitudinal direction of the base material, a large amount of scrap is inevitably produced.

In order to cut the rectangular unit pieces at the predetermined angle, there is generally used an array structure in which cutters (for example, knives) are arranged in the cutting frame such that the rectangular unit pieces corresponding to the cutters are adjacent to one another.

In connection with this matter, FIGS. 1 and 2 typically illustrate a conventional cutting frame in which rectangular unit pieces are located on a base material to construct cutters corresponding to the rectangular unit pieces. For convenience of description, the base material is illustrated to have a predetermined length.

Referring to these drawings, a plurality of desired rectangular unit pieces 20 are cut from a base material sheet 10 having a predetermined width and a long length. In a cutting frame 30 are arranged a plurality of cutters 32 corresponding to the rectangular unit pieces 20. Consequently, the array structure of the rectangular unit pieces 20 is substantially identical to that of the cutters 32.

The cutters 32 are mounted or formed in the cutting frame 30 such that the cutters 32 can cut a predetermined number (six in FIG. 1 and eight in FIG. 2) of the rectangular unit pieces 20 through a one-time cutting process. Consequently, the base material sheet 10 is cut by the cutting frame 30, and then the base material sheet 10 is cut again by the cutting frame 30 while the base material sheet 10 is overlapped by a predetermined length s in the longitudinal direction L of the base material sheet 10. In this way, a series of cutting processes are carried out.

Each rectangular unit piece 20 is constructed in a rectangular structure in which a longitudinal side a of each rectangular unit piece 20 is longer than a lateral side b of each rectangular unit piece 20. Also, each rectangular unit piece 20 is inclined at an angle a of approximately 45 degrees to the longitudinal direction of the base material sheet 10. When the inclined rectangular unit pieces 20 are arranged on the base material sheet 10, it is possible to generally consider two array structures of the rectangular unit pieces as shown in FIGS. 1 and 2.

The first array structure of the rectangular unit pieces is to sequentially arrange the rectangular unit pieces such that the lateral sides b of the respective rectangular unit pieces coincide with one another, as shown in FIG. 1. According to this array structure, it is possible to cut a total of 24 rectangular unit pieces 20 from a base material sheet 10 having an effective width W and length L. However, it is not possible to cut a rectangular unit piece 21 located at a position deviating from the effective width W of the base material sheet 10.

In this array structure, only a cutting width D, not the effective width W, of the base material sheet 10 is substantially used, and therefore, the remaining width W-D is disposed of as scrap. Since the rectangular unit pieces 20 are inclined at an angle of approximately 45 degrees, scrap is also inevitably produced at the upper end region of the base material sheet 10.

The second array structure of the rectangular unit pieces is to sequentially arrange the rectangular unit pieces such that the longitudinal sides a of the respective rectangular unit pieces coincide with one another, as shown in FIG. 2. According to this array structure, it is possible to cut a total of 19 rectangular unit pieces 20 from a base material sheet 10 having an effective width W and length L.

In consideration of the above description, it can be seen that the cutting efficiency may vary according to the array structure of the rectangular unit pieces. However, when the rectangular unit pieces are inclined at a specific angle to the base material sheet, it is not easy to arrange the rectangular unit pieces in various array structures. For this reason, only the array structure of the rectangular unit pieces in which specific sides (longitudinal sides or lateral sides) of the respective rectangular unit pieces coincided with one another as shown in FIG. 1 or 2 is mainly considered in the conventional art.

Furthermore, when two or more kinds of rectangular unit pieces having different sizes are to be cut from the same base material, the array structure of the rectangular unit pieces is very complicated. For this reason, consideration is given to only the array structure of the rectangular unit pieces in which specific sides of the respective rectangular unit pieces coincide with one another or central axes of the respective rectangular unit pieces coincide with one another (see FIG. 6).

Consequently, when an array structure of the rectangular unit pieces exhibiting higher cutting efficiency than that of the array structures of the rectangular unit pieces as shown in FIGS. 1 and 2 is provided, it is possible to lower the cutting loss and eventually reduce the manufacturing costs of products. The improvement of the cutting efficiency is more and more serious especially when the price of the base material is high and/or the rectangular unit pieces are to be manufactured on a large scale.

### SUMMARY OF THE INVENTION

Therefore, the present invention has been made to solve the above problems, and other technical problems that have yet to be resolved.

As a result of a variety of extensive and intensive studies and experiments on a cutting frame, the inventors of the present invention have found that, when cutters are formed in a specific array structure of rectangular unit pieces, which will be hereinafter described in detail, such that the cutters correspond to the respective rectangular unit pieces, the cutting efficiency is greatly improved as compared with the conventional array structure of the rectangular unit pieces. The present invention has been completed based on these findings.

Specifically, it is an object of the present invention to provide a cutting frame including cutters formed to exhibit high cutting efficiency when cutting a plurality of rectangular unit pieces inclined at a predetermined angle to the longitudinal direction of a rectangular base material having a relatively large size from the rectangular base material.

It is another object of the present invention to provide a scrap having bores corresponding to the rectangular unit pieces arranged in the array structure of the rectangular unit pieces exhibiting the high cutting efficiency as described above.

In accordance with one aspect of the present invention, the above and other objects can be accomplished by the provision of a cutting frame including a plurality of cutters for cutting two or more kinds of rectangular unit pieces having relatively small sizes from a rectangular base material at a predetermined inclination, the cutters being mounted or formed in the cutting frame such that the cutters correspond to the rectangular unit pieces, wherein the cutters are formed in the cutting frame in an array structure of the rectangular unit pieces in which largest-sized rectangular unit pieces are arranged at a central part of a base material based on the height of the base material in the longitudinal direction of the base material, and small-sized rectangular unit pieces are arranged above and below the largest-sized rectangular unit pieces.

The ‘largest-sized rectangular unit pieces’ mean the rectangular unit pieces having the largest area among a series of the rectangular unit pieces arranged at the rectangular base material. The ‘small-sized rectangular unit pieces’ mean the remaining rectangular unit pieces having a size less than that of the largest-sized rectangular unit pieces among a series of the rectangular unit pieces arranged at the rectangular base material.

Consequently, the largest-sized rectangular unit pieces are arranged at the central part of the base material based on the height of the base material in the longitudinal direction of the base material, and the small-sized rectangular unit pieces are arranged above and below the largest-sized rectangular unit pieces, thereby achieving high cutting efficiency.

The inventors of the present invention have prepared and examined various array structures of the rectangular unit pieces and found out that, when the largest-sized rectangular unit pieces are arranged at the central part of the base material, the cutting efficiency is improved, and this array structure of the rectangular unit pieces greatly reduces the number of cases produced when two or more kinds of the rectangular unit pieces are arranged in correspondence to the cutters mounted in the cutting frame, thereby greatly simplifying the manufacturing process of the cutting frame.

One of the reasons why the array structure of the rectangular unit pieces according to the present invention exhibits relatively high cutting efficiency is that the size of upper end and lower end cutout parts inevitably produced when the rectangular unit pieces are arranged at a predetermined inclination is minimized by arranging the relatively small-sized rectangular unit pieces at the uppermost row and the lowermost row of the array structure of the rectangular unit pieces. The upper end and lower end cutout parts are decided by the length of each side of the respective rectangular unit pieces and the inclination of the rectangular unit pieces. The upper end and lower end cutout parts are disposed of except in a special case.

According to circumstances, an assembly (‘combination’) of two small-sized rectangular unit pieces adjacent to each other at a long side of each rectangular unit piece such that the long sides of the respective rectangular unit pieces coincide with each other may be arranged at the central part of the base material when the combination has a size greater than that of each largest-sized rectangular unit piece.

That is, when the size of the combination of the two small-sized rectangular unit pieces is greater that that of each largest-sized rectangular unit piece, the combination is considered as another rectangular unit piece having a size greater than that of each largest-sized rectangular unit piece, and therefore, the combination may have a priority to be arranged at the central part of the base material.

When the cutting frame is constructed to cut three or more kinds of rectangular unit pieces, each rectangular unit piece constituting the combination may have a smallest size based on the above array structure of the rectangular unit pieces.

For example, when three or more kinds of rectangular unit pieces have similar sizes, a combination of two smallest-sized rectangular unit pieces adjacent to each other at a long side of each rectangular unit piece such that the long sides of the respective rectangular unit pieces coincide with each other may be a largest-sized rectangular unit piece. This combination is arranged at the central part of the base material, and other rectangular unit pieces are arranged above and below the combination, thereby improving cutting efficiency.

In a preferred embodiment, a large majority of the rectangular unit pieces arranged at the base material are arranged while being adjacent to other rectangular unit pieces at four sides of each rectangular unit piece. In the array structure of the rectangular unit pieces according to the conventional art, two sides of each rectangular unit piece, among four sides of each rectangular unit piece, are adjacent to two other rectangular unit pieces for each side, and the remaining two sides of each rectangular unit piece are adjacent to another rectangular unit piece for each side. According to the conventional art, therefore, the number of other rectangular unit pieces to which a large majority of the rectangular unit pieces each can be adjacent is six (see FIG. 1) or five (see FIG. 2).

In consideration of this matter, the rectangular unit pieces are somewhat offset from one another such that each side of any arbitrary rectangular unit piece is adjacent to only another rectangular unit piece in the preferred array structure of the rectangular unit pieces as described above. In this array structure of the rectangular unit pieces, at least some combinations of adjacent four rectangular unit pieces form an island-type residue in the center thereof. The ‘island-type residue’ means a residue having a relatively large size produced by the offset array structure of the rectangular unit pieces. This island-type residue is left at a scrap produced after cutting the base material in a small rectangular shape.

Consequently, the number of the combinations of every adjacent four rectangular unit pieces forming the island-type residue in the center thereof while being arranged in the specific array structure as described above is preferably not less than 50%, more preferably not less than 90%, of the number of the remaining rectangular unit pieces excluding the uppermost row rectangular unit pieces and the lowermost row rectangular unit pieces, although it may vary depending upon the kind and number of the rectangular unit pieces.

Also, when two kinds of the rectangular unit pieces are cut or when the sizes of the rectangular unit pieces are not in direct proportion although three or more kinds of the rectangular unit pieces are cut, island-type residues are produced for most combinations of the rectangular unit pieces. The island-type residues may have the same size or different sizes.

That is, the cutting frame with the above-stated construction is characterized in that, although the rectangular unit pieces are arranged while being adjacent to one another as shown in FIGS. 1 and 2, one side of one rectangular unit piece does not completely coincide with, but is somewhat offset from, the corresponding side of another rectangular unit piece. This array structure of the rectangular unit pieces is not the structure that can be generally easily considered when the cutters are arranged in the cutting frame to cut inclined rectangular unit pieces. However, it was confirmed that this unique array structure of the rectangular unit pieces provides higher cutting efficiency than the conventional cutting frame to our surprise.

The cutting frame exhibits higher cutting efficiency than the conventional cutting frame by the unique array structure of the rectangular unit pieces including the island-type residues as defined above because the unit pieces are constructed in a rectangular structure, and the rectangular unit pieces are cut while being inclined at a predetermined angle to the longitudinal direction of the base material.

The inventors of the present invention confirmed that, when the unit pieces are constructed in a square structure or the unit pieces are cut while not being inclined, the cutting efficiency is further improved by an array structure in which the unit pieces are arranged while being adjacent to one another such that the opposite sides coincide with one another. Consequently, the cutting frame with the above-stated construction is preferably used to cut the rectangular unit pieces while the rectangular unit pieces are inclined at a predetermined angle.

In the present invention, the base material may be a separate single material on which one-time or several-time cutting processes can be carried out or a continuous material having a predetermined width and a relatively very long length. The latter may be a long base material sheet. In this case, the base material sheet may be unwound from a roller, and the unwound base material sheet is sequentially cut by the cutting frame. In consideration of the manufacturing production efficiency and economical efficiency of the rectangular unit pieces, the base material is preferably a continuous material.

As previously described, all the rectangular unit pieces are cut from the base material while being inclined at a predetermined angle to the longitudinal direction of the base material. The rectangular unit pieces may be cut while being inclined at the predetermined angle to the base material, for example, when inherent physical properties of the base material in the longitudinal direction or in the lateral direction must be expressed by a predetermined angle with respect to the rectangular unit pieces. For example, the rectangular unit pieces may be inclined at an angle of 20 to 70 degrees.

In a preferred embodiment, the base material is a film including layers (‘absorption layers or transmission layers’) that absorb or transmit only a specific-direction wave motion of light or an electromagnetic wave in the longitudinal direction or in the lateral direction, and the rectangular unit pieces cut from the base material is a relatively small-sized film of which the absorption layers or the transmission layers are inclined at an angle of 45 degrees.

In the present invention, the array structure of the rectangular unit pieces substantially coincide with the cutters of the cutting frame or the array structure of the cutters. Consequently, it is interpreted that the array structure of the rectangular unit pieces means the cutters or the array structure of the cutters, so long as an additional description is not given.

The kind of the cutters is not particularly restricted so long as the cutters exhibit the structure or properties to cut the rectangular unit pieces from the base material. Typically, each of the cutters may be a knife for cutting, such as a metal knife or a jet water knife, or a light source for cutting, such as laser.

Meanwhile, when small-sized rectangular unit pieces having a size sufficient to be included in the upper end and lower end cutout parts of the base material are to be cut together, the array structure of the rectangular unit pieces is designed in consideration of only the relatively large-sized rectangular unit pieces, and then the small-sized rectangular unit pieces are located at the upper end and lower end cutout parts of the base material. This array structure of the rectangular unit pieces is preferred in the aspect of designing the cutting frame because the cutting efficiency is further improved by the array structure of the rectangular unit pieces.

Consequently, in a cutting frame including a plurality of cutters for cutting two or more kinds of rectangular unit pieces from the rectangular base material at a predetermined inclination, the cutters being mounted or formed in the cutting frame such that the cutters correspond to the rectangular unit pieces, the cutters may be arranged such that smallest-sized rectangular unit pieces Y are located only on the upper end and/or lower end cutout parts of the base material in an array of the remaining rectangular unit pieces excluding the smallest-sized rectangular unit pieces Y.

The ‘upper end and/or lower end cutout parts’ mean residues produced at the upper end and/or the lower end regions of the rectangular base material after cutting the rectangular unit pieces having sizes greater than that of the smallest-sized rectangular unit pieces Y from the base material by the cutters.

The cutout parts are included in a scrap, which will be disposed of after the cutting. Consequently, when the rectangular unit pieces are cut from the base material, the smallest-sized rectangular unit pieces Y are also cut from the cutout parts of the base material, whereby further improving the cutting efficiency.

Also, the number of cases may be reduced when two or more kinds of the rectangular unit pieces are arranged, and therefore, it is possible to greatly simplify the manufacturing process of the cutting frame. That is, the array structure of the remaining rectangular unit pieces excluding the smallest-sized rectangular unit pieces Y is constructed, and then the smallest-sized rectangular unit pieces Y are appropriately located at the cutout parts of the base material, thereby achieving a desired array structure of the rectangular unit pieces.

Consequently, the above-described array structure of the rectangular unit pieces is constructed by a process, for example, including arranging the remaining rectangular unit pieces excluding the rectangular unit pieces Y at a maximum cutting area ratio and arranging the rectangular unit pieces Y on the upper end and/or lower end cutout parts of the base material.

The ‘cutting area ratio’ means percentage of a value obtained by dividing the areas of the rectangular unit pieces arranged on the base material by the total area of the base material. In this specification, the cutting area ratio is used as a meaning similar to the cutting efficiency.

Preferably, each of the rectangular unit pieces Y satisfies conditions of Equation (1) below with respect to each rectangular unit piece X having a size greater than that of each rectangular unit piece Y.

D≦Ls×sin θ (1)

Where, D is a diagonal length of each rectangular unit piece Y, Ls is a length of a short side of each rectangular unit piece X, and θ is an inclination angle of the respective rectangular unit pieces.

In Equation (1) above, Ls×sin θ corresponds to the height of a short side of each rectangular unit piece X. Consequently, when the diagonal length D of each rectangular unit piece Y is less than or equal to the height of the short side of each rectangular unit piece X, the above-described array structure of the rectangular unit pieces is constructed. The above conditions are preferred in an aspect in which the manufacturing production efficiency is improved by a cutting margin, which will be described hereinafter.

The inclination angle θ may vary depending upon inherent physical properties of the base material in the longitudinal direction or in the lateral direction, as previously described. For example, the inclination angle θ may be 45 degrees.

In accordance with another aspect of the present invention, there is provided a scrap obtained after cutting two or more kinds of rectangular unit pieces from a base material at a predetermined inclination.

Specifically, the scrap according to the present invention is characterized in that a plurality of bores corresponding to the rectangular unit pieces are continuously connected to one another by a cutting margin, the largest-sized rectangular unit piece bores are arranged at the central part of the scrap based on the height of the scrap in the longitudinal direction of the scrap, and the small-sized rectangular unit piece bores are arranged above and below the largest-sized rectangular unit pieces.

The shape of the rectangular unit piece bores of the scrap reflects the cutters of the cutting frame or the array shape of the cutters. Consequently, in the cutting frame corresponding to the scrap, the cutters are spaced apart from each other between the rectangular unit pieces by a cutting margin, and the cutters are arranged such that the largest-sized rectangular unit piece bores are arranged at the central part of the scrap, and the small-sized rectangular unit piece bores are arranged above and below the largest-sized rectangular unit pieces.

Generally, the cutting frame independently cuts a plurality of small-sized rectangular unit pieces from a large-sized rectangular base material through the use of the cutters. Consequently, when the rectangular unit pieces are in full contact with one another, i.e., facing sides of the adjacent rectangular unit pieces are simultaneously formed by a single cutter, it is difficult to handle the rectangular unit pieces as independent unit pieces at a cutting process and subsequent processes. For this reason, it is more preferred to arrange the rectangular unit pieces such that a small cutting margin is provided between the respective rectangular unit pieces. Consequently, the region where the rectangular unit pieces are adjacent to one another is constructed in a structure having a narrow and long cutting margin.

### BRIEF DESCRIPTION OF THE DRAWINGS

The above and other objects, features and other advantages of the present invention will be more clearly understood from the following detailed description taken in conjunction with the accompanying drawings, in which:

FIGS. 1 and 2 are typical views illustrating a conventional cutting frame in which rectangular unit pieces are located on a base material to construct cutters corresponding to the rectangular unit pieces;

FIG. 3 is a typical view illustrating a cutting frame according to a preferred embodiment of the present invention in which two kinds of rectangular unit pieces are located on a base material to construct cutters corresponding to the rectangular unit pieces;

FIG. 4 is a typical view partially illustrating two kinds of rectangular unit pieces according to another preferred embodiment of the present invention located on a base material;

FIG. 5 is a typical view partially illustrating three kinds of rectangular unit pieces according to another preferred embodiment of the present invention located on a base material;

FIG. 6 is a typical view partially illustrating an array structure of rectangular unit pieces according to another preferred embodiment of the present invention when two kinds of the rectangular unit pieces are arranged; and

FIG. 7 is a typical view partially illustrating the shape of a scrap according to a preferred embodiment of the present invention.

### DETAILED DESCRIPTION OF PREFERRED EMBODIMENTS

Now, preferred embodiments of the present invention will be described in detail with reference to the accompanying drawings. It should be noted, however, that the scope of the present invention is not limited by the illustrated embodiments.

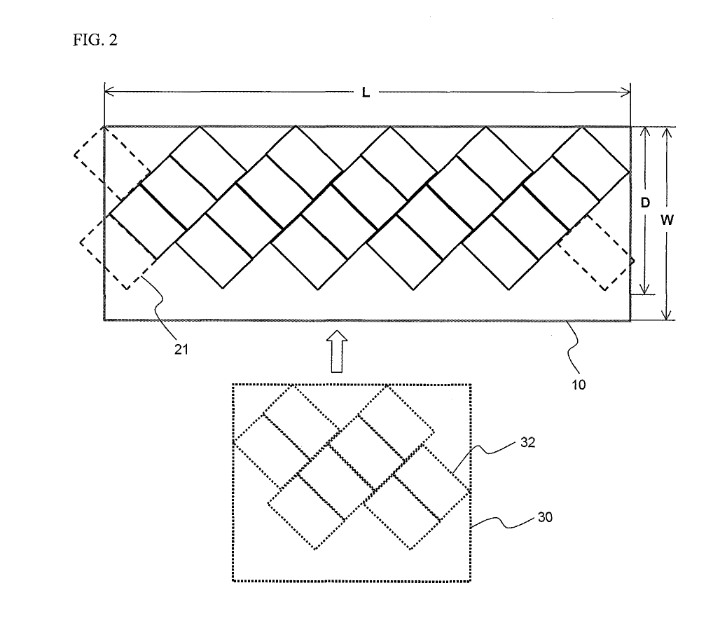

FIG. 3 is a typical view illustrating a cutting frame according to a preferred embodiment of the present invention in which two kinds of rectangular unit pieces are located on a base material to construct cutters corresponding to the rectangular unit pieces.

Referring to FIG. 3, relatively large-sized rectangular unit pieces A are arranged at a central part, including a center line C, of a base material within an effective width W of the base material in the longitudinal direction L of the base material, and relatively small-sized rectangular unit pieces B are arranged above and below the relatively large-sized rectangular unit pieces A such that a cutting margin 120 is defined between the rectangular unit pieces B and the corresponding rectangular unit pieces A.

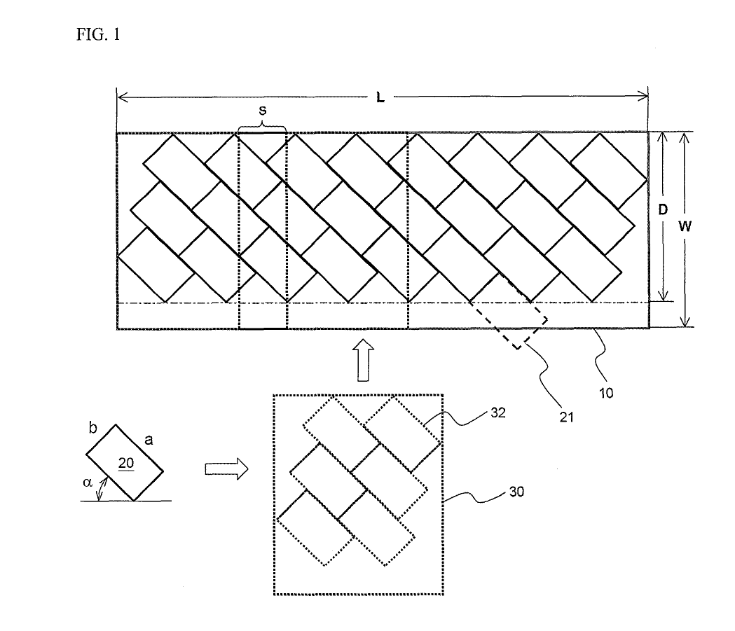

Also, the rectangular unit pieces are arranged such that one rectangular unit piece 200 is adjacent to other rectangular unit pieces (only rectangular unit pieces 210 and 230 are illustrated in FIG. 3) at four sides thereof but is not adjacent to one rectangular unit piece 220. In comparison with this array structure, one rectangular unit piece is in contact with six other rectangular unit pieces in the array structure of the rectangular unit pieces as shown in FIG. 1, and one rectangular unit piece is in contact with five other rectangular unit pieces in the array structure of the rectangular unit pieces as shown in FIG. 2. Consequently, some sides of the rectangular unit pieces are simultaneously in contact with two other rectangular unit pieces in the array structures of the rectangular unit pieces as shown in FIGS. 1 and 2. For reference, FIG. 3 illustrates only two rectangular unit pieces 210 and 230 adjacent to the rectangular unit piece 200 but not two other rectangular unit pieces for simplicity of illustration.

Also, the rectangular unit pieces are arranged such that an island-type residue 110 is formed among the adjacent four rectangular unit pieces 200, 210, 220, and 230 (see a circle drawn by an alternated long and short dash line). The island-type residue 110 is an approximately rectangular residue defined by the respective sides of the rectangular unit pieces 200, 210, 220, and 230. This structure is not seen from the array structures of FIGS. 1 and 2 at all.

In the array structure of the rectangular unit pieces as described above, the utilization of the base material sheet 10 is greater than that in FIG. 1. Preferably, the effective width W of the base material sheet 10 is substantially almost equal to the cutting width D (see FIG. 1 or 2).

Also, a cutting margin 120 having a size less than that of the island-type residue 110 is located between the rectangular unit pieces 200 and 210, which are adjacent to each other at one side of each rectangular unit piece. Consequently, when the rectangular unit pieces 200, 210, 220, and 230 are cut from the base material sheet 10, the respective rectangular unit pieces are effectively cut as independent unit pieces by the cutters of the cutting frame.

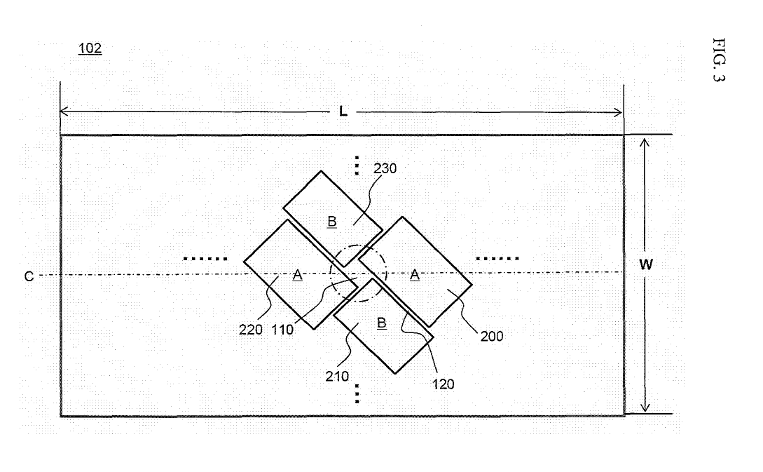

FIG. 4 is a typical view partially illustrating two kinds of rectangular unit pieces according to another preferred embodiment of the present invention located on a base material.

Referring to FIG. 4, a combination 2B includes two relatively small-sized rectangular unit pieces adjacent to each other at a long side 130 of each rectangular unit piece such that the long sides 130 of the respective rectangular unit pieces coincide with each other. The combination 2B has a size greater than that of each relatively large-sized rectangular unit piece A. The combination 2B is located at the central part of the base material.

The respective rectangular unit pieces B of the combination 2B may be arranged such that the long sides 130 of the respective rectangular unit pieces B are adjacent to each other with a cutting margin 120 or such that the long sides 130 of the respective rectangular unit pieces B are in contact with each other without the cutting margin 120.

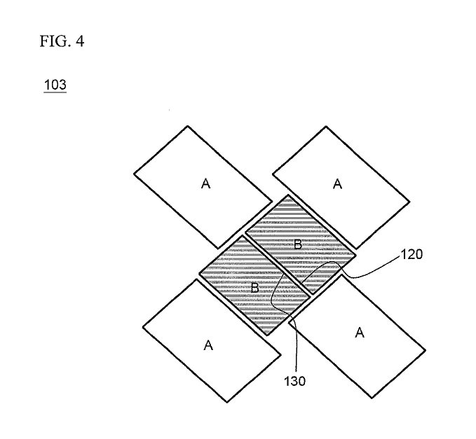

FIG. 5 is a typical view partially illustrating three kinds of rectangular unit pieces according to another preferred embodiment of the present invention located on a base material.

Referring to FIG. 5, an inclination θ is an angle between the upper end line 12 of the base material and a rectangular unit piece X. Consequently, the maximum height 150 of a short side of the rectangular unit piece X from the upper end line 12 of the base material is calculated by the production of the length Ls of the short side of the rectangular unit piece X and a sine function value of the inclination θ.

In an array structure 104 of rectangular unit pieces in which rectangular unit pieces X constitute the uppermost row, therefore, smallest-sized rectangular unit pieces Y have a diagonal length 140 less than or equal to the maximum height 150 of the short side of each rectangular unit piece X from the upper end line 12 of the base material such that each smallest-sized rectangular unit piece Y is located in each upper end cutout part 160 of the base material. Of course, even when this condition is not satisfied, i.e., the diagonal length 140 of each rectangular unit piece X is greater than the maximum height 150 of the short side of each rectangular unit piece X from the upper end line 12 of the base material, each rectangular unit piece X may be located in the corresponding upper end cutout part 160 of the base material. However, productivity is improved, when a predetermined cutting margin is secured between the corresponding rectangular unit pieces X and Y, and therefore, the array structure of the rectangular unit pieces satisfying the above condition is more preferred.

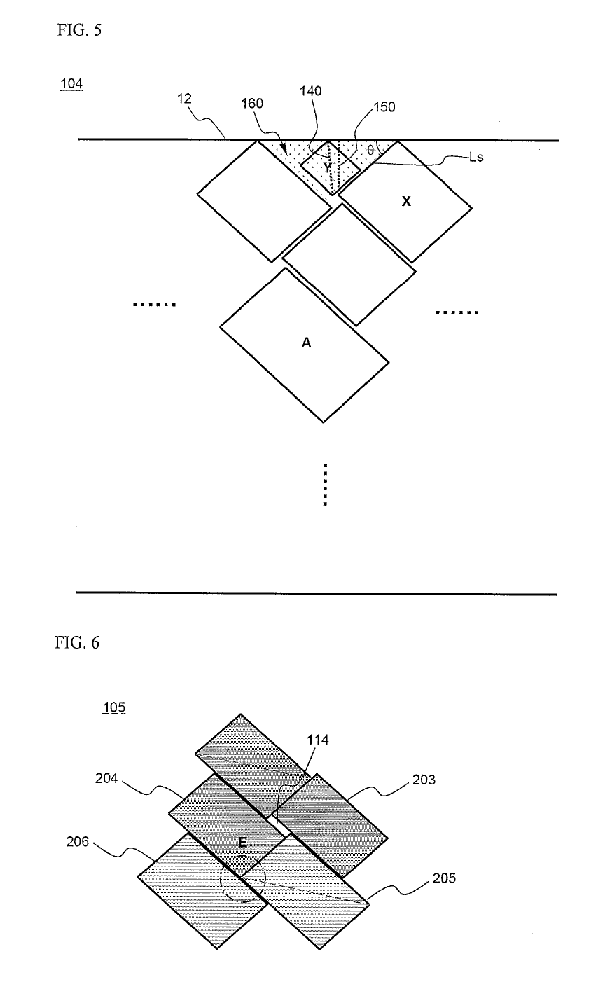

FIG. 6 is a typical view partially illustrating an array structure of rectangular unit pieces according to another preferred embodiment of the present invention when two kinds of the rectangular unit pieces are arranged.

Referring to FIG. 6, there is partially illustrated an exemplary array structure 105 of rectangular unit pieces in which relatively small-sized rectangular unit pieces 203 and 204 and relatively large-sized rectangular unit pieces 205 and 206 having a size ratio of 30:34 are arranged in a number ratio of 2:3. Here, the size ratio is set based on the diagonal lengths of the respective rectangular unit pieces 203, 204, 205, and 206.

An island-type residue 114 is included in the array structure of the rectangular unit pieces including the relatively small-sized rectangular unit pieces 203 and 204 and the relatively large-sized rectangular unit pieces 205 and 206. Consequently, this array structure of rectangular unit pieces is different from the conventional array structure of rectangular unit pieces.

According to the array structure of the rectangular unit pieces, no island-type residue 114 may be formed at a specific region E at which some rectangular unit pieces 204, 205, and 206 are in contact with one another. In the array structure of the rectangular unit pieces according to this embodiment, however, the island-type residue 114 is necessarily included in the combination of at least some rectangular unit pieces.

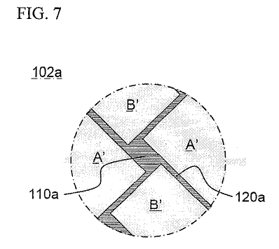

FIG. 7 is a typical view partially illustrating the shape of a scrap according to a preferred embodiment of the present invention.

Referring to FIG. 7, the scrap 102a is obtained after cutting a plurality of rectangular unit pieces from a base material according to the array structure of the rectangular unit pieces as shown in FIG. 3. Specifically, when the base material is sequentially cut by a cutting frame including the array structure of the rectangular unit pieces as shown in FIG. 3, it is possible to obtain the scrap 102a in which a plurality of bores A′ and B′ corresponding to the rectangular unit pieces are continuously connected to one another by a cutting margin 120a, the relatively large-sized rectangular unit piece bores A′ are arranged at the central part of the base material (not shown) based on the height of the base material in the longitudinal direction of the base material, and the relatively small-sized rectangular unit piece bores B′ are arranged above and below the relatively large-sized rectangular unit pieces A′.

Also, an island-type residue 110a having a size greater than that of the cutting margin 120a is formed among the adjacent four rectangular unit piece bores A′ and B′ of the scrap 102a.

### INDUSTRIAL APPLICABILITY

As apparent from the above description, the cutting frame according to the present invention exhibits high cutting efficiency through a unique and regular array structure of rectangular unit pieces when the rectangular unit pieces, of which the direction particularity is required according to the properties of a material, are to be cut from a base material while the rectangular unit pieces are inclined to the base material. In particular, when a large amount of rectangular unit pieces are produced through mass production, it is possible to greatly reduce the total manufacturing costs of the rectangular unit pieces based on the high cutting efficiency.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A cutting frame including a plurality of cutters for cutting two or more kinds of rectangular unit pieces having relatively small sizes from a rectangular base material at a predetermined inclination, the cutters being mounted or formed in the cutting frame such that the cutters correspond to the rectangular unit pieces, wherein
the cutters are formed in the cutting frame in an array structure of the rectangular unit pieces in which largest-sized rectangular unit pieces are arranged at a central part of a base material based on the height of the base material in the longitudinal direction of the base material, and small-sized rectangular unit pieces are arranged above and below the largest-sized rectangular unit pieces.

2. The cutting frame according to claim 1, wherein an assembly (‘combination’) of two small-sized rectangular unit pieces adjacent to each other at a long side of each rectangular unit piece such that the long sides of the respective rectangular unit pieces coincide with each other is arranged at the central part of the base material when the combination has a size greater than that of each largest-sized rectangular unit piece.

3. The cutting frame according to claim 2, wherein the cutting frame is constructed to cut three or more kinds of rectangular unit pieces, and each rectangular unit piece constituting the combination has a smallest size.

4. The cutting frame according to claim 1, wherein a large majority of the rectangular unit pieces are arranged while being adjacent to other rectangular unit pieces at four sides of each rectangular unit piece, and at least some combinations of adjacent four rectangular unit pieces have an island-type residue formed in the center thereof.

5. The cutting frame according to claim 4, wherein the number of the combinations of the rectangular unit pieces having the island-type residue formed in the center thereof is not less than 50% of the total number of the rectangular unit pieces.

6. The cutting frame according to claim 1, wherein the base material is a continuous material having a predetermined width and a relatively very long length.

7. The cutting frame according to claim 1, wherein the rectangular unit pieces are inclined at an angle of 20 to 70 degrees.

8. The cutting frame according to claim 1, wherein the base material is a film including layers (‘absorption layers or transmission layers’) that absorb or transmit only a specific-direction wave motion of light or an electromagnetic wave in the longitudinal direction or in the lateral direction, and each of the rectangular unit pieces cut from the base material is a relatively small-sized film of which the absorption layers or the transmission layers are inclined at an angle of 45 degrees.

9. The cutting frame according to claim 1, wherein each of the cutters is a knife for cutting or a light source for cutting.

10. The cutting frame according to claim 1, wherein the cutters are arranged such that smallest-sized rectangular unit pieces (Y) are located only on upper end and/or lower end cutout parts of the base material in an array of the remaining rectangular unit pieces excluding the smallest-sized rectangular unit pieces (Y).

11. The cutting frame according to claim 10, wherein each of the rectangular unit pieces (Y) satisfies conditions of Equation (1) below with respect to each rectangular unit piece (X) having a size greater than that of each rectangular unit piece (Y).
D≦Ls×sin θ (1)
Where,
D is a diagonal length of each rectangular unit piece (Y),
Ls is a length of a short side of each rectangular unit piece (X), and
θ is an inclination angle of the respective rectangular unit pieces.

12. The cutting frame according to claim 10, wherein the array structure of the rectangular unit pieces is constructed by a process including arranging the remaining rectangular unit pieces excluding the rectangular unit pieces (Y) at a maximum cutting area ratio and arranging the rectangular unit pieces (Y) on the upper end and/or lower end cutout parts of the base material.

13. A scrap obtained after cutting two or more kinds of rectangular unit pieces from a base material at a predetermined inclination,
wherein a plurality of bores corresponding to the rectangular unit pieces are continuously connected to one another by a cutting margin, the largest-sized rectangular unit piece bores are arranged at the central part of the scrap based on the height of the scrap in the longitudinal direction of the scrap, and the small-sized rectangular unit piece bores are arranged above and below the largest-sized rectangular unit pieces.
